(19) United States
(12) Patent Application Publication
(10) Pub. No.: US 2026/0213404 A1
(43) Pub. Date: Jul. 23, 2026

(54) ANTENNA SPRING AND ELECTRONIC DEVICE

(71) Applicant: HONOR DEVICE CO., LTD., Shenzhen (CN)

(72) Inventors: Bin Yan, Shenzhen (CN); Yu Wang, Shenzhen (CN)

(73) Assignee: HONOR DEVICE CO., LTD., Shenzhen (CN)

(21) Appl. No.: 19/571,797

(22) Filed: Mar. 19, 2026

Related U.S. Application Data
(63) Continuation of application No. PCT/CN2024/109376, filed on Aug. 2, 2024.

(30) Foreign Application Priority Data
Oct. 30, 2023 (CN) 202311431181.9
Feb. 8, 2024 (CN) 202410178126.1

(51) Int. Cl. H01Q 3/02; H01Q 1/42

(52) U.S. Cl. CPC H01Q 3/02; H01Q 1/42

(57) ABSTRACT

An antenna spring and an electronic device are provided. The electronic device includes a frame, an antenna spring, a circuit board, and an electrically conductive elastic piece. The antenna spring, the circuit board, and the electrically conductive elastic piece are all mounted on an inner side of the frame. The frame includes a frame antenna, the antenna spring is located between the frame antenna and the circuit board, and the antenna spring includes a fastening portion, an abutting portion, and a connecting portion. The fastening portion and the abutting portion are both fixedly connected to the connecting portion, the fastening portion is fixedly connected to the frame antenna, and a projection of the abutting portion on the connecting portion is spaced from the fastening portion. The electrically conductive elastic piece is mounted on a side that is of the circuit board and that faces the antenna spring.

### CROSS-REFERENCE TO RELATED APPLICATIONS

This application is a continuation of International Application No. PCT/CN2024/109376, filed on Aug. 2, 2024, which claims priority to Chinese Patent Application No. 202311431181.9, filed on Oct. 30, 2023, and Chinese Patent Application No. 202410178126.1, filed on Feb. 8, 2024, all of which are incorporated herein by reference in their entireties.

### TECHNICAL FIELD

This application relates to the field of electronic device technologies, and in particular, to an antenna spring and an electronic device.

### BACKGROUND

An antenna is an important component that ensures high use reliability and stability of an electronic device such as a mobile phone. Currently, electrical conduction between the antenna and a circuit board of the electronic device may be implemented by using an antenna spring. To adapt to a mounting position of the circuit board in the electronic device, a spot welding surface of an existing antenna spring is usually disposed obliquely, which, however, causes the antenna spring to occupy relatively large mounting space, thereby reducing space utilization in the electronic device, and adversely affecting miniaturization design of the electronic device.

### SUMMARY

An objective of embodiments of this application is to provide an antenna spring and an electronic device, which can reduce mounting space of the antenna spring and improve space utilization in the electronic device, thereby facilitating miniaturization design of the electronic device.

According to a first aspect, an embodiment of this application provides an electronic device, including a frame, an antenna spring, a circuit board, and an electrically conductive elastic piece. The antenna spring, the circuit board, and the electrically conductive elastic piece are all mounted on an inner side of the frame. The frame includes a frame antenna, the antenna spring is located between the frame antenna and the circuit board, and the antenna spring includes a fastening portion, an abutting portion, and a connecting portion. The fastening portion and the abutting portion are both fixedly connected to the connecting portion, the fastening portion is fixedly connected to the frame antenna, and a projection of the abutting portion on the connecting portion is spaced from the fastening portion. The electrically conductive elastic piece is mounted on a side that is of the circuit board and that faces the antenna spring, and abuts against the abutting portion. In the electronic device provided in this application, the projection of the abutting portion of the antenna spring on the connecting portion is spaced from the fastening portion, so that the abutting portion and the fastening portion can be decoupled, thereby reducing a distance between the frame antenna and a joint of the abutting portion and the connecting portion, and further reducing mounting space of the antenna spring in the electronic device, improving space utilization in the electronic device, and facilitating miniaturization design of the electronic device.

In a possible implementation, the abutting portion and the fastening portion at least partially overlap in a thickness direction of the electronic device. In such an arrangement, mounting space of the abutting portion and the fastening portion in the thickness direction of the electronic device may be reused, thereby reducing a thickness of the electronic device, and helping implement miniaturization design of the electronic device.

In a possible implementation, the frame antenna includes a fastening surface, the fastening surface faces the inner side of the frame, the fastening portion is fixedly connected to the fastening surface, and a maximum distance between the fastening surface and the joint of the abutting portion and the connecting portion is less than 2 mm. A distance between the fastening surface and the joint of the abutting portion and the connecting portion is greater than or equal to 0.05 mm. For example, the distance between the fastening surface and the joint of the abutting portion and the connecting portion is equal to or greater than 0.1 mm, and is less than or equal to 0.5 mm. In such an arrangement, the distance between the fastening surface of the frame antenna and the joint of the abutting portion and the connecting portion may be reduced to a relatively small value, thereby reducing mounting space occupied by the antenna spring in the electronic device.

In a possible implementation, the fastening portion is provided with a plurality of solder joint positions, and the plurality of solder joint positions are successively arranged in a length direction of the antenna spring. In such an arrangement, a size of the antenna spring in the length direction may be increased, thereby helping improve structural strength of the antenna spring, and further enhancing welding reliability between the antenna spring and the frame antenna.

In a possible implementation, the fastening portion includes two sub-fastening portions, the two sub-fastening portions are respectively and fixedly connected to two opposite sides of the connecting portion in the length direction of the antenna spring, the two sub-fastening portions are both spaced from the projection of the abutting portion on the connecting portion in a width direction of the antenna spring, and each of the sub-fastening portions is provided with at least one of the solder joint positions. In this embodiment, the two sub-fastening portions of the fastening portion each can be welded with the frame antenna, thereby helping enhance welding reliability between the antenna spring and the frame antenna.

In a possible implementation, each of the sub-fastening portions is provided with a plurality of solder joint positions, and the plurality of solder joint positions are successively arranged in the length direction of the antenna spring, or the plurality of solder joint positions are successively arranged in the thickness direction of the electronic device, or some of the solder joint positions are successively arranged in the length direction of the antenna spring, and some of the solder joint positions are successively arranged in the thickness direction of the electronic device. In such an arrangement, the antenna spring can be fastened to the frame antenna in relatively small mounting space, thereby helping improve design flexibility of an electrical connection between the antenna spring and the frame antenna.

In a possible implementation, the connecting portion includes two sub-connecting portions, and the two sub-connecting portions are respectively and fixedly connected to two opposite sides of the fastening portion in the length direction of the antenna spring. The abutting portion includes two sub-abutting portions, each of the sub-abutting portions is fixedly connected to one of the sub-connecting portions, and a projection of the sub-abutting portion on the sub-connecting portion is spaced from the fastening portion. In this embodiment, there are two electrically conductive elastic pieces, and each of the electrically conductive elastic pieces abuts against one of the sub-abutting portions. One electrically conductive elastic piece is used to feed power to a middle frame antenna, and the other electrically conductive elastic piece is used to tune a signal in the middle frame antenna. In this embodiment, the two sub-abutting portions are disposed on the antenna spring, so that the electrically conductive elastic piece used to feed power and the electrically conductive elastic piece used to tune a signal may be both mounted on one antenna spring, and an antenna spring used to feed power and an antenna spring used to tune a signal do not need to be separately mounted in the electronic device, thereby reducing the mounting space occupied by the antenna spring in the electronic device, improving space utilization in the electronic device, and further helping facilitate miniaturization design of the electronic device.

In a possible implementation, the fastening portion has a first end and a second end, the first end and the second end are disposed opposite to each other in the thickness direction of the electronic device, and a distance between the first end and the second end is equal to or greater than 0.6 mm. In such an arrangement, it can be ensured that the fastening portion has a sufficiently large welding area, thereby ensuring welding stability between the fastening portion and the frame antenna.

In a possible implementation, the electronic device further includes a support plate, the support plate is located on the inner side of the frame, and is fixedly connected to the frame, the support plate is provided with a mounting groove and an avoidance groove, an opening of the mounting groove is located on a bottom surface of the support plate, and an opening of the avoidance groove is located on a groove bottom wall surface of the mounting groove. The antenna spring, the circuit board, and the electrically conductive elastic piece are all mounted in the mounting groove, and the fastening portion extends into the avoidance groove, thereby reducing mounting space of the antenna spring, and improving space utilization in the electronic device.

In a possible implementation, the antenna spring includes a first end face that faces away from a groove bottom wall of the avoidance groove, and the first end face is lower than an edge that is of the fastening surface and that faces away from a groove bottom wall surface of the avoidance groove, or the first end face is flush with the edge that is of the fastening surface and that faces away from the groove bottom wall surface of the avoidance groove, to prevent the first end face of the antenna spring from exceeding the edge that is of the fastening surface and that faces away from the groove bottom wall surface of the avoidance groove, thereby further helping facilitate miniaturization design of the electronic device.

In a possible implementation, a distance between the first end face and the joint of the abutting portion and the connecting portion is equal to or greater than 0.2 mm. In such an arrangement, the distance between the first end face and the joint of the abutting portion and the connecting portion may be reduced to a relatively small value, thereby helping improve structural design freedom of the antenna spring.

According to a second aspect, this application further provides an antenna spring, used in an electronic device, where the antenna spring includes a fastening portion, an abutting portion, and a connecting portion. The fastening portion and the abutting portion are both fixedly connected to the connecting portion, the fastening portion is fixedly connected to the frame antenna, and a projection of the abutting portion on the connecting portion is spaced from the fastening portion. In the antenna spring provided in this application, the projection of the abutting portion on the connecting portion is spaced from the fastening portion, so that the abutting portion and the fastening portion can be decoupled, thereby reducing a distance between the frame antenna and a joint of the abutting portion and the connecting portion, and further reducing mounting space of the antenna spring in the electronic device, improving space utilization in the electronic device, and facilitating miniaturization design of the electronic device.

In a possible implementation, the fastening portion, the abutting portion, and the connecting portion are integrally molded, to facilitate processing and molding of the antenna spring.

### BRIEF DESCRIPTION OF DRAWINGS

To describe technical solutions in embodiments of this application or in the BACKGROUND section more clearly, the following describes accompanying drawings required in the embodiments of this application or in the BACKGROUND section.

FIG. 1 is a schematic diagram of a structure of an electronic device according to an embodiment of this application;

FIG. 2 is a schematic diagram of a partial structure of the electronic device shown in FIG. 1;

FIG. 3 is a schematic diagram of a structure of an assembly of a circuit board and an electronic component in the electronic device shown in FIG. 1;

FIG. 4 is a schematic diagram of a cross-sectional structure of the electronic device shown in FIG. 2 cut along A-A;

FIG. 5 is a schematic diagram of an exploded structure of the electronic device shown in FIG. 2;

FIG. 6 is a schematic enlarged view of a region B in FIG. 5;

FIG. 7 is a schematic diagram of a cross-sectional structure obtained after cutting along a line B-B in FIG. 6;

FIG. 8 is a schematic diagram of a structure of an antenna spring in the electronic device shown in FIG. 2 in a first embodiment;

FIG. 9 is a schematic diagram of a partial structure of the electronic device shown in FIG. 2 in a second embodiment;

FIG. 10 is a schematic diagram of a structure of an antenna spring in the electronic device shown in FIG. 9;

FIG. 11 is a schematic diagram of a partial structure of the electronic device shown in FIG. 2 in a third embodiment;

FIG. 12 is a schematic diagram of a structure of an antenna spring in the electronic device shown in FIG. 11;

FIG. 13 is a schematic diagram of a partial structure of the electronic device shown in FIG. 2 in a fourth embodiment;

FIG. 14 is a schematic diagram of a structure of an antenna spring in the electronic device shown in FIG. 13;

FIG. 15 is a schematic diagram of a partial structure of the electronic device shown in FIG. 2 in a fifth embodiment;

FIG. 16 is a schematic diagram of a structure of an antenna spring in the electronic device shown in FIG. 15;

FIG. 17 is a schematic diagram of a partial structure of the electronic device shown in FIG. 2 in a sixth embodiment; and

FIG. 18 is a schematic diagram of a structure of an antenna spring in the electronic device shown in FIG. 17.

### DETAILED DESCRIPTION OF EMBODIMENTS

The following describes embodiments of this application with reference to accompanying drawings in the embodiments of this application.

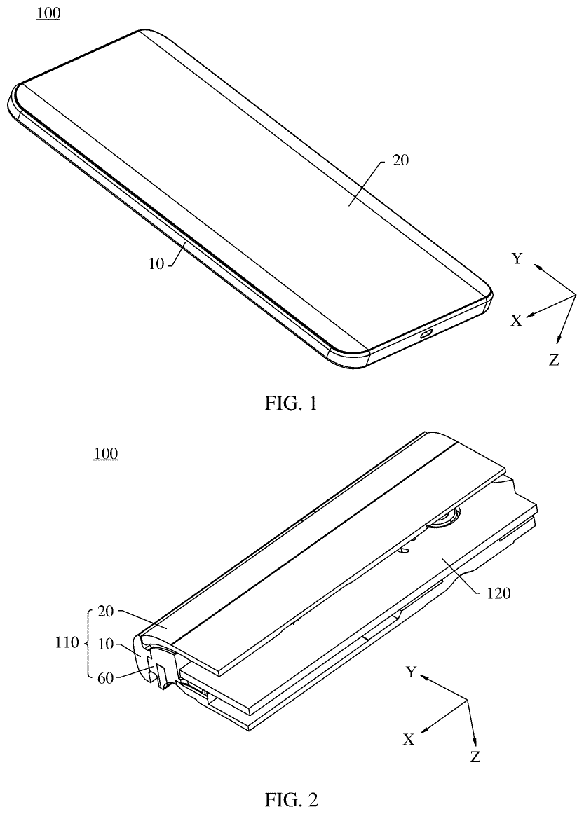

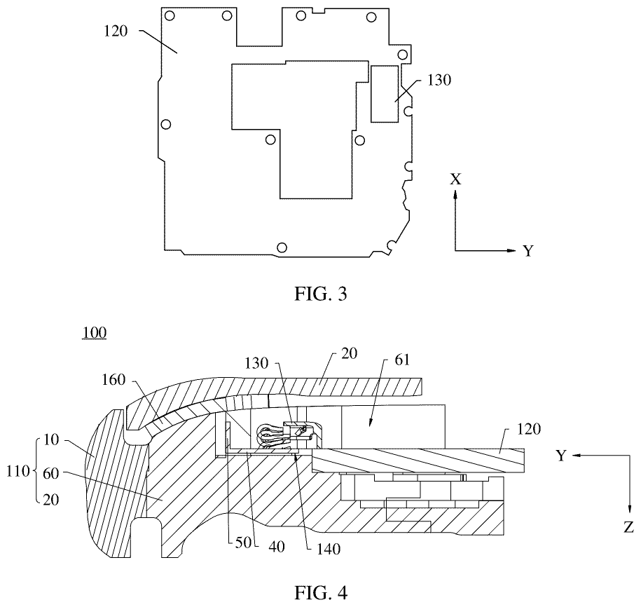

Refer to FIG. 1 to FIG. 3. FIG. 1 is a schematic diagram of a structure of an electronic device 100 according to an embodiment of this application. FIG. 2 is a schematic diagram of a partial structure of the electronic device 100 shown in FIG. 1. FIG. 3 is a schematic diagram of a structure of an assembly of a circuit board 120 and an electronic component 130 in the electronic device 100 shown in FIG. 1.

An embodiment of this application provides an electronic device 100. The electronic device 100 includes but is not limited to a device that is loaded with an antenna assembly, such as a mobile phone, a tablet computer, a notebook computer, or a wearable device. The wearable device may be a smart band, a smartwatch, augmented reality (AR) glasses, virtual reality (VR) glasses, or the like. In this embodiment of this application, an example in which the electronic device 100 is the mobile phone is used for description. For ease of description, a width direction of the electronic device 100 is defined as an X-axis direction, a length direction of the electronic device 100 is defined as a Y-axis direction, a thickness direction of the electronic device is defined as a Z-axis direction, and the X-axis direction, the Y-axis direction, and the Z-axis direction are perpendicular to each other.

In this embodiment, the electronic device 100 may include a housing 110, a circuit board 120, an electronic component 130, a battery (not shown in the figure), and a display screen (not shown in the figure). The circuit board 120, the electronic component 130, and the battery (not shown in the figure) are all mounted on an inner side of the housing 110. For example, the circuit board 120 has a structure of an approximately hollow-square plate shape. The circuit board 120 may be used as a main board of the electronic device 100. The electronic component 130 is mounted on the circuit board 120, and is electrically connected to the circuit board 120. For example, the electronic component 130 may be a radio frequency antenna component. The battery is electrically connected to the circuit board 120. The battery may be used as a power source of the electronic device 100 to provide electric energy for the electronic component 130. The display screen is mounted on a side of the housing 110, and is electrically connected to the circuit board 120. The display screen may be used as a display component of the electronic device 100, and is configured to display information such as a picture or a text.

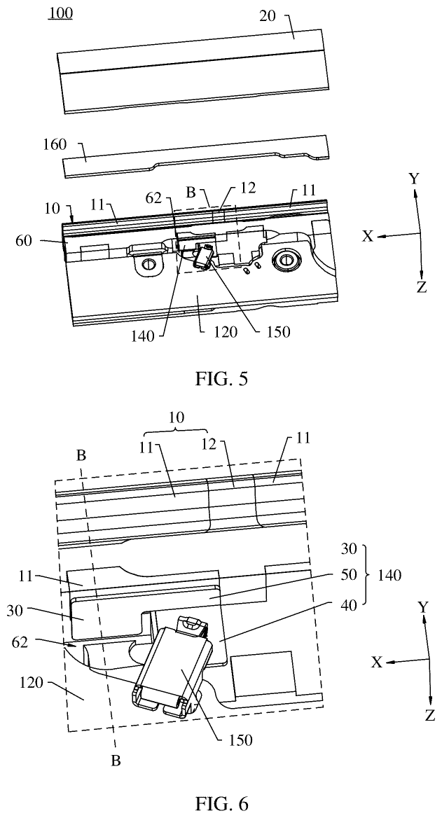

Refer to FIG. 4 to FIG. 6. FIG. 4 is a schematic diagram of a cross-sectional structure of the electronic device 100 shown in FIG. 2 cut along A-A. FIG. 5 is a schematic diagram of an exploded structure of the electronic device 100 shown in FIG. 2. FIG. 6 is a schematic enlarged view of a region B in FIG. 5.

In this embodiment, the housing 110 includes a frame 10, a support plate 60, and a rear cover 20. The support plate 60 is located on an inner side of the frame 10, and is fixedly connected to the frame 10. The support plate 60 is provided with a mounting groove 61 and an avoidance groove 62. An opening of the mounting groove 61 is located on a bottom surface of the support plate 60, and the mounting groove 61 is recessed in a direction from the bottom surface to a top surface of the support plate 60. The mounting groove 61 may receive the circuit board 120. In other words, the circuit board 120 is mounted in the mounting groove 61. To be specific, the circuit board 120 is mounted on the inner side of the frame 10. An opening of the avoidance groove 62 is located on a groove bottom wall surface of the mounting groove 61. The avoidance groove 62 is recessed from the groove bottom wall surface of the mounting groove 61 to the top surface of the support plate 60.

It should be noted that it should be noted that orientation words such as “top” and “bottom” in this application are described with reference to orientations shown in FIG. 1. Using an orientation toward a positive direction of the Z-axis as the “top” and an orientation toward a negative direction of the Z-axis as the “bottom” does not indicate or imply that a referred apparatus or element must have a specific orientation or be constructed and operated in a specific orientation, and therefore should not be understood as a limitation on this application.

The rear cover 20 is mounted on a bottom side of the support plate 60, and is connected to the frame 10. The rear cover 20 and the display screen are respectively located on two opposite sides of the frame 10 in a thickness direction (the Z-axis direction shown in the figure) of the electronic device 100. When a user uses the electronic device 100, the display screen is disposed facing the user, and the rear cover 20 is disposed facing away from the user.

The frame 10 includes a frame antenna 11 and an insulation part 12. There may be a plurality of frame antennas 11. The plurality of frame antennas 11 are spaced from each other in the X-axis direction. Each of the frame antennas 11 includes a fastening surface 111, and the fastening surface 111 is disposed facing the inner side of the frame 10. The frame antenna 11 is configured to ensure normal communication of the electronic device 100. The insulation part 12 is fixedly connected between two adjacent frame antennas 11.

In addition, the electronic device 100 further includes a connecting member 160, and the connecting member 160 is fixedly connected between the rear cover 20 and the support plate 60, to implement fastening between the rear cover 20 and the support plate 60. In this embodiment, the connecting member 160 may be an adhesive. For example, a length of an orthographic projection of the connecting member 160 on the support plate 60 is 1.6 mm in the Z-axis direction.

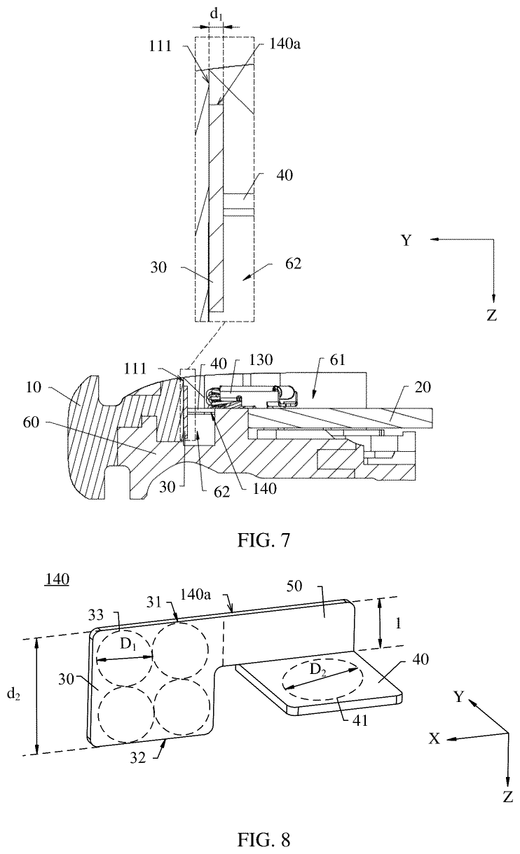

Refer to FIG. 6 to FIG. 8. FIG. 7 is a schematic diagram of a cross-sectional structure obtained after cutting along a line B-B in FIG. 6. FIG. 8 is a schematic diagram of a structure of an antenna spring 140 in the electronic device 100 shown in FIG. 2 in a first embodiment.

The electronic device 100 further includes the antenna spring 140 and an electrically conductive elastic piece 150. The antenna spring 140 and the electrically conductive elastic piece 150 are both mounted in the mounting groove 61, and are both located on the inner side of the frame 10. The antenna spring 140 is fixedly mounted on an inner side of the frame antenna 11 and is electrically connected to the frame antenna 11, and is spaced from the circuit board 120. The electrically conductive elastic piece 150 is electrically connected between the antenna spring 140 and the circuit board 120.

In this embodiment, the antenna spring 140 is made of a metal material. The antenna spring 140 includes a first end face 140a that faces away from a groove bottom wall of the avoidance groove 62. The first end face 140a is lower than an edge that is of the fastening surface 111 of the frame antenna 11 and that faces away from the groove bottom wall surface of the avoidance groove 62, or the first end face 140a is flush with the edge that is of the fastening surface 111 and that faces away from the groove bottom wall surface of the avoidance groove 62. The antenna spring 140 further includes a fastening portion 30, an abutting portion 40, and a connecting portion 50. The fastening portion 30 and the abutting portion 40 are both fixedly connected to the connecting portion 50. For example, the fastening portion 30, the abutting portion 40, and the connecting portion 50 may be integrally molded. For example, one or more of processing techniques such as cutting, bending, and stamping may be used, so that the fastening portion 30, the abutting portion 40, and the connecting portion 50 are integrally molded.

In this embodiment, the fastening portion 30 and the connecting portion 50 are located on a same plane. Specifically, the fastening portion 30 is fixedly mounted on the fastening surface 111 of the frame antenna 11, and extends into the avoidance groove 62, so that the antenna spring 140 is fastened to the inner side of the frame antenna 11, thereby implementing the electrical connection between the antenna spring 140 and the frame antenna 11. For example, the fastening portion 30 may be fastened to the fastening surface 111 of the frame antenna 11 through welding.

The fastening portion 30 has a first end 31 and a second end 32, and the first end 31 and the second end 32 are disposed opposite to each other in the thickness direction (the Z-axis direction shown in the figure) of the electronic device 100. A distance d₂ between the first end 31 and the second end 32 is equal to or greater than 0.6 mm. The fastening portion 30 is further provided with a plurality of solder joint positions 33. For example, there are four solder joint positions 33, all of which are in a circular shape. The four solder joint positions 33 are arranged in two rows and two columns. A diameter D₁ of each of the solder joint positions 33 is equal to or greater than 0.6 mm. In such an arrangement, it can be ensured that the fastening portion 30 has a sufficiently large welding area, thereby ensuring welding stability between the fastening portion 30 and the frame antenna 11.

In this embodiment, a projection of the abutting portion 40 on the connecting portion 50 is spaced from the fastening portion 30. For example, the projection of the abutting portion 40 on the connecting portion 50 is spaced from the fastening portion 30 in the length direction (the Y-axis direction shown in the figure) of the electronic device 100. A distance between the projection of the abutting portion 40 on the connecting portion 50 and the fastening portion 30 is equal to or greater than 0.25 mm. For example, the abutting portion 40 and the connecting portion 50 are perpendicular to each other. In some other embodiments, the abutting portion 40 and the connecting portion 50 may alternatively be disposed obliquely. In this embodiment, the abutting portion 40 extends in a direction that is far away from the frame antenna 11 in a thickness direction (the Y-axis direction shown in the figure) of the connecting portion 50. For example, a length of the abutting portion 40 is 1.5 mm in the Y-axis direction. An end that is of the abutting portion 40 and that is far away from the connecting portion 50 is spaced from the circuit board 120. A distance l between the first end face 140a and the joint of the abutting portion 40 and the connecting portion 50 is equal to or greater than 0.2 mm.

In this embodiment, a distance d₁ between the fastening surface 111 of the frame antenna 11 and the joint of the abutting portion 40 and the connecting portion 50 is greater than or equal to 0.05 mm, and a maximum distance between the fastening surface 111 of the frame antenna 11 and the joint of the abutting portion 40 and the connecting portion 50 is less than 2 mm. In the length direction (the Y-axis direction shown in the figure) of the electronic device 100, the distance d₁ between the fastening surface 111 of the frame antenna 11 and the joint of the abutting portion 40 and the connecting portion 50 is greater than or equal to 0.09 mm, and the maximum distance between the fastening surface 111 of the frame antenna 11 and the joint of the abutting portion 40 and the connecting portion 50 is less than 1.03 mm. For example, the distance d₁ between the fastening surface 111 and the joint of the abutting portion 40 and the connecting portion 50 is equal to or greater than 0.1 mm, and is less than or equal to 0.5 mm. In the length direction (the Y-axis direction shown in the figure) of the electronic device 100, the distance d₁ between the fastening surface 111 and the joint of the abutting portion 40 and the connecting portion 50 is equal to or greater than 0.1 mm, and is less than or equal to 0.3 mm. In addition, the abutting portion 40 and the fastening portion 30 at least partially overlap in the thickness direction (the Z-axis direction shown in the figure) of the electronic device 100. In such an arrangement, mounting space between the abutting portion 40 and the fastening portion 30 in the thickness direction of the electronic device 100 may be reused, thereby reducing a thickness of the electronic device 100, and helping implement miniaturization design of the electronic device 100.

In this embodiment, the abutting portion 40 is provided with an elastic contact point 41. For example, the elastic contact point 41 is in a circular shape. A diameter D₂ of the elastic contact point 41 is equal to or greater than 0.8 mm. It may be understood that the projection of the abutting portion 40 on the connecting portion 50 is spaced from the fastening portion 30, so that the elastic contact point 41 of the abutting portion 40 and the solder joint position 33 of the fastening portion 30 may be decoupled, thereby causing the distance between the first end face 140a and the joint of the abutting portion 40 and the connecting portion 50 to be capable of being reduced to a relatively small value, without being restricted by a magnitude of the diameter of the solder joint position 33. In such an arrangement, on the one hand, the distance between the first end face 140a and the joint of the abutting portion 40 and the connecting portion 50 may be reduced, thereby reducing the distance between the fastening surface 111 of the frame antenna 11 and the joint of the abutting portion 40 and the connecting portion 50, and further reducing mounting space occupied by the antenna spring 140 in the electronic device 100, improving space utilization in the electronic device 100, and facilitating miniaturization design of the electronic device 100. On the other hand, space reserved for the frame antenna 11 in the electronic device 100 may also be increased, thereby increasing antenna clearance of the frame antenna 11, and helping improve use performance of the frame antenna 11. In addition, structural design freedom of the antenna spring 140 may also be improved. In addition, the antenna spring provided in this application does not occupy a surface, used to bond the connecting member 160, of the support plate 60, which can ensure that the area, used to bond the connecting member 160, of the support plate 60 remains unchanged, thereby ensuring high connection reliability between the support plate 60 and the rear cover 20.

Refer again to FIG. 4 and FIG. 6. The electrically conductive elastic piece 150 is mounted on a side that is of the circuit board 120 and that faces the antenna spring 140, and abuts against the abutting portion 40 of the antenna spring 140. Specifically, an end of the electrically conductive elastic piece 150 elastically abuts against the elastic contact point 41 of the abutting portion 40 of the antenna spring 140, so that the electrically conductive elastic piece 150 is electrically connected to the antenna spring 140. The other end of the electrically conductive elastic piece 150 is electrically connected to the circuit board 120, so that the antenna spring 140 can be electrically conducted with the circuit board 120. The electrically conductive elastic piece 150 may be used to feed power to the frame antenna 11, or be used to tune a signal in the frame antenna 11.

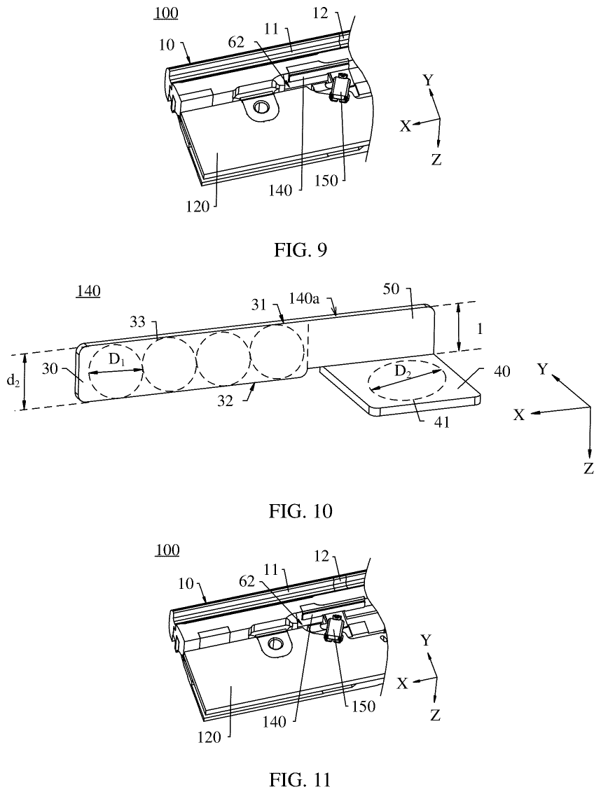

Refer to FIG. 9 and FIG. 10. FIG. 9 is a schematic diagram of a partial structure of the electronic device 100 shown in FIG. 2 in a second embodiment. FIG. 10 is a schematic diagram of a structure of an antenna spring 140 in the electronic device 100 shown in FIG. 9.

A difference between the electronic device 100 provided in this embodiment and the electronic device 100 provided in the foregoing first embodiment lies in that the plurality of solder joint positions 33 are successively arranged in a length direction of the fastening portion 30. For example, the length direction of the fastening portion 30 is parallel to the width direction (the X-axis direction shown in the figure) of the electronic device 100. In such an arrangement, a length of the antenna spring 140 in the X-axis direction may be increased, thereby helping improve structural strength of the antenna spring 140, and further enhancing welding reliability between the antenna spring 140 and the frame antenna 11.

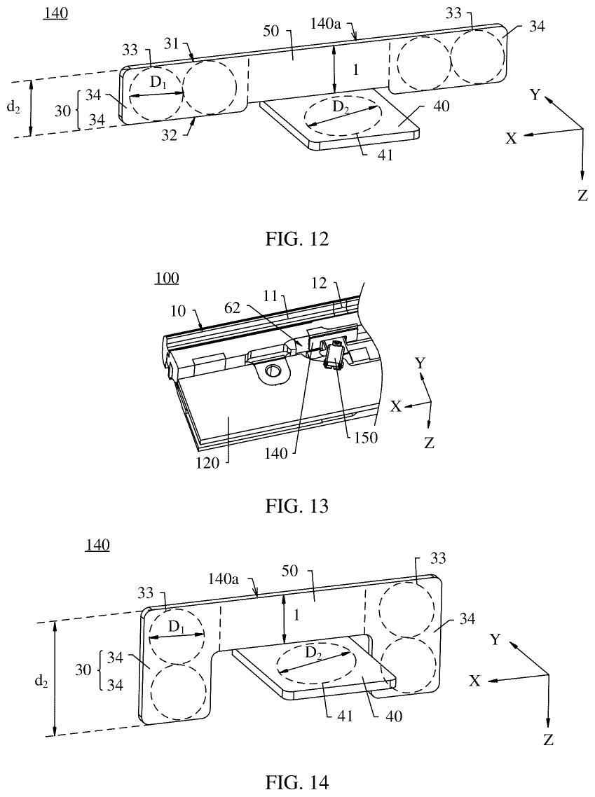

Refer to FIG. 11 and FIG. 12. FIG. 11 is a schematic diagram of a partial structure of the electronic device 100 shown in FIG. 2 in a third embodiment. FIG. 12 is a schematic diagram of a structure of an antenna spring 140 in the electronic device 100 shown in FIG. 11.

A difference between the electronic device 100 provided in this embodiment and the electronic device 100 provided in the foregoing first embodiment lies in that the fastening portion 30 of the antenna spring 140 in the electronic device 100 includes two sub-fastening portions 34. The two sub-fastening portions 34 are respectively and fixedly connected to two opposite sides of the fastening portion 50 in the length direction of the antenna spring 140, and each extend from the connecting portion 50 in a direction that is far away from the connecting portion 50. Extension directions of the two sub-fastening portions 34 are opposite to each other. For example, the length direction of the antenna spring 140 is parallel to the width direction (the X-axis direction shown in the figure) of the electronic device 100. Each of the sub-fastening portions 34 is spaced from the projection of the abutting portion 40 on the connecting portion 50 in a width direction of the antenna spring 140. In addition, each of the sub-fastening portions 34 is provided with at least one solder joint position 33. For example, the width direction of the antenna spring 140 is parallel to the length direction (the Y-axis direction shown in the figure) of the electronic device 100.

In this embodiment, each of the sub-fastening portions 34 is provided with a plurality of solder joint positions 33, and the plurality of solder joint positions 33 are successively arranged in the length direction of the antenna spring 140. For example, the length direction of the antenna spring 140 is parallel to the width direction (the X-axis direction shown in the figure) of the electronic device 100. In such an arrangement, the two sub-fastening portions 34 of the fastening portion 30 each can be welded with the frame antenna 11, thereby helping enhance welding reliability between the antenna spring 140 and the frame antenna 11.

Refer to FIG. 13 and FIG. 14. FIG. 13 is a schematic diagram of a partial structure of the electronic device 100 shown in FIG. 2 in a fourth embodiment. FIG. 14 is a schematic diagram of a structure of an antenna spring 140 in the electronic device 100 shown in FIG. 13.

A difference between the electronic device 100 provided in this embodiment and the electronic device 100 provided in the foregoing third embodiment lies in that a plurality of solder joint positions 33 are successively arranged in the thickness direction (the Z-axis direction shown in the figure) of the electronic device 100. To be specific, in the Z-axis direction, the two sub-fastening portions 34 each extend from the connecting portion 50 in a direction toward the groove bottom wall of the avoidance groove 62. Extension directions of the two sub-fastening portions 34 are the same.

In such an arrangement, a length size of each of the sub-fastening portions 34 in the X-axis direction may be reduced, so that the antenna spring 140 can still be fastened to the frame antenna 11 in relatively small mounting space, thereby helping improve flexibility of connection between the antenna spring 140 and the frame antenna 11, and design flexibility of an electrical connection between other components in the electronic device 100.

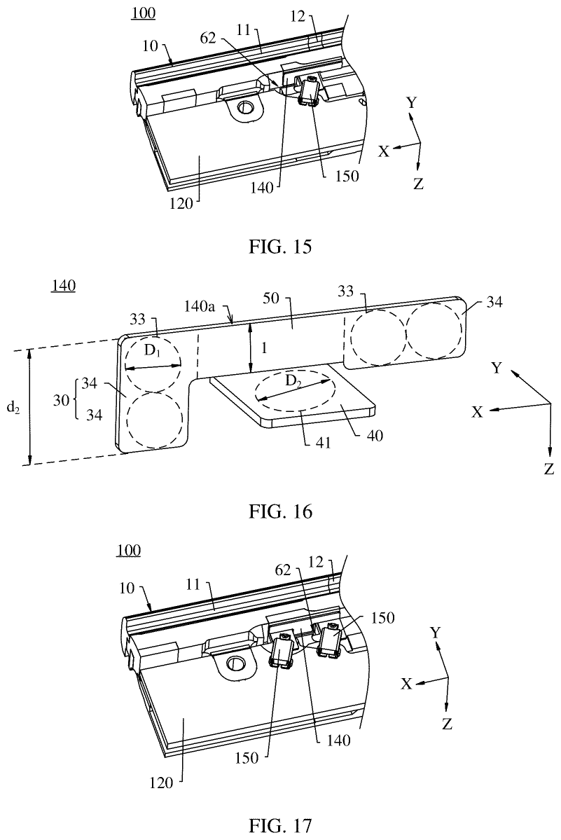

Refer to FIG. 15 and FIG. 16. FIG. 15 is a schematic diagram of a partial structure of the electronic device 100 shown in FIG. 2 in a fifth embodiment. FIG. 16 is a schematic diagram of a structure of an antenna spring 140 in the electronic device 100 shown in FIG. 15.

A difference between the electronic device 100 provided in this embodiment and the electronic device 100 provided in the foregoing third embodiment lies in that some solder joint positions 33 are successively arranged in the length direction (the X-axis direction shown in the figure) of the antenna spring 140, and some solder joint positions 33 are successively arranged in the thickness direction (the Z-axis direction shown in the figure) of the electronic device 100. To be specific, in the X-axis direction, one sub-fastening portion 34 extends from the connecting portion 50 in a direction that is far away from the connecting portion 50, and in the Z-axis direction, the other sub-fastening portion 34 extends from the connecting portion 50 in a direction toward the groove bottom wall of the avoidance groove 62. In such an arrangement, the antenna spring 140 can still be fastened to the frame antenna 11 in smaller mounting space, thereby helping improve design flexibility of an electrical connection between the antenna spring 140 and the frame antenna 11.

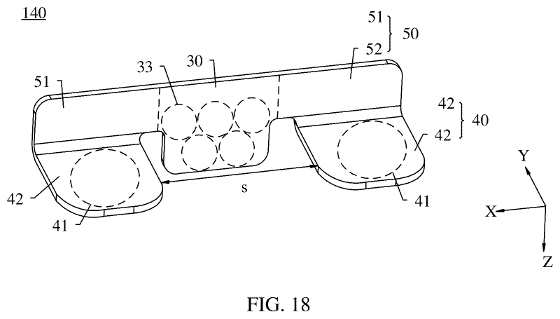

Refer to FIG. 17 and FIG. 18. FIG. 17 is a schematic diagram of a partial structure of the electronic device 100 shown in FIG. 2 in a sixth embodiment. FIG. 18 is a schematic diagram of a structure of an antenna spring 140 in the electronic device 100 shown in FIG. 17.

A difference between the electronic device 100 provided in this embodiment and the electronic device 100 provided in the foregoing first embodiment lies in that the connecting portion 50 of the antenna spring 140 in the electronic device 100 includes two sub-connecting portions 51, and in the length direction of the antenna spring 140, the two sub-connecting portions 51 are respectively and fixedly connected to two opposite sides of the fastening portion 30, and each extend from the fastening portion 30 in a direction that is far away from the fastening portion 30. Extension directions of the two sub-connecting portions 51 are opposite to each other. For example, the length direction of the antenna spring 140 is parallel to the width direction (the X-axis direction shown in the figure) of the electronic device 100.

In this embodiment, the abutting portion 40 of the antenna spring 140 includes two sub-abutting portions 42. The two sub-abutting portions 42 are respectively located on two opposite sides of the fastening portion 30 in the length direction of the antenna spring 140. For example, the length square of the antenna spring 140 is parallel to the width direction (the X-axis direction shown in the figure) of the electronic device 100. A minimum distance s between the two sub-abutting portions 42 is between 2 mm and 10 mm. For example, the minimum distance s between the two sub-abutting portions 42 is 2.1 mm.

Each of the sub-abutting portions 42 is fixedly connected to one of the sub-connecting portions 51. A projection of the sub-abutting portion 42 on the sub-connecting portion 51 is spaced from the fastening portion 30. For example, the projection of the sub-abutting portion 42 on the sub-connecting portion 51 is spaced from the fastening portion 30 in the width direction of the antenna spring 140. The width direction of the antenna spring 140 is parallel to the length direction (the Y-axis direction shown in the figure) of the electronic device 100. Each of the sub-abutting portions 42 extends in a direction that is far away from the frame antenna 11 in a thickness direction (the Y-axis direction shown in the figure) of the sub-connecting portion 51. An end that is of each of the sub-abutting portions 42 and that is far away from the sub-connecting portion 51 is spaced from the circuit board 120. Each of the sub-abutting portions 42 is provided with the elastic contact point 41. For example, each of the sub-abutting portions 42 is perpendicular to one of the sub-connecting portions 51. In some other embodiments, each of the sub-abutting portions 42 may alternatively be obliquely perpendicular to one of the sub-connecting portions 51.

In this embodiment, there are two electrically conductive elastic pieces 150. The two electrically conductive elastic pieces 150 are both mounted on a side that is of the circuit board 120 and that faces the antenna spring 140. Each of the electrically conductive elastic pieces 150 abuts against one of the sub-abutting portions 42 of the antenna spring 140. Specifically, one end of the electrically conductive elastic piece 150 elastically abuts against the elastic contact point 41 of the sub-abutting portion 42, so that the electrically conductive elastic piece 150 is electrically connected to the antenna spring 140. The other end of the electrically conductive elastic piece 150 is electrically connected to the circuit board 120, so that the antenna spring 140 can be electrically conducted with the circuit board 120.

In this embodiment, one electrically conductive elastic piece 150 is used to feed power to the frame antenna 11, and the other electrically conductive elastic piece 150 is used to tune a signal in the frame antenna 11. It may be understood that the two sub-abutting portions 42 are disposed on the antenna spring 140, so that the electrically conductive elastic piece 150 used to feed power and the electrically conductive elastic piece 150 used to tune a signal each can be mounted on one antenna spring 140, and the antenna spring 140 used to feed power and the antenna spring 140 used to tune a signal do not need to be separately mounted in the electronic device 100, thereby reducing mounting space occupied by the antenna spring 140 in the electronic device 100, improving space utilization in the electronic device 100, and further helping facilitate miniaturization design of the electronic device 100.

According to the antenna spring 140 provided in this embodiment of this application, the projection of the abutting portion 40 on the connecting portion 50 is spaced from the fastening portion 30, so that the elastic contact point 41 of the abutting portion 40 and the solder joint position 33 of the fastening portion 30 can be decoupled, thereby reducing the distance between the fastening surface 111 of the frame antenna 11 and the joint of the abutting portion 40 and the connecting portion 50, and further reducing mounting space of the antenna spring 140 in the electronic device 100, improving space utilization in the electronic device 100, and facilitating miniaturization design of the electronic device 100. In addition, layout difficulty of other components of the electronic device 100 may also be reduced. On this basis, a manner of arranging the solder joint positions 33 in the fastening portion 30 is changed, so that structural design freedom of the antenna spring 140 is greater, thereby improving design flexibility of an electrical connection between the antenna spring 140 and the frame antenna 11, and further facilitating fastening between the antenna spring 140 and the frame antenna 11.

The foregoing descriptions are only some embodiments and implementations of this application, and are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. An electronic device, comprising:
a frame;
an antenna spring;
a circuit board; and
an electrically conductive elastic piece,
wherein the antenna spring, the circuit board, and the electrically conductive elastic piece are all mounted on an inner side of the frame, the frame comprises a frame antenna, and the antenna spring is located between the frame antenna and the circuit board;
the antenna spring comprises a fastening portion, an abutting portion, and a connecting portion, wherein the fastening portion and the abutting portion are both fixedly connected to the connecting portion, the fastening portion is fixedly connected to the frame antenna, and a projection of the abutting portion on the connecting portion is spaced from the fastening portion; and
the electrically conductive elastic piece is mounted on a side that is of the circuit board and that faces the antenna spring, and abuts against the abutting portion;
wherein the fastening portion comprises two sub-fastening portions, the two sub-fastening portions are respectively and fixedly connected to two opposite sides of the connecting portion in a length direction of the antenna spring, the two sub-fastening portions are both spaced from the projection of the abutting portion on the connecting portion in a width direction of the antenna spring, and each of the sub-fastening portions is provided with at least one solder joint position.

2. The electronic device according to claim 1, wherein the abutting portion and the fastening portion at least partially overlap in a thickness direction of the electronic device.

3. The electronic device according to claim 1, wherein the frame antenna comprises a fastening surface, the fastening surface faces the inner side of the frame, the fastening portion is fixedly connected to the fastening surface, and a maximum distance between the fastening surface and a joint of the abutting portion and the connecting portion is less than 2 mm.

4. The electronic device according to claim 3, wherein a distance between the fastening surface and the joint of the abutting portion and the connecting portion is greater than or equal to 0.05 mm.

5. The electronic device according to claim 4, wherein the distance between the fastening surface and the joint of the abutting portion and the connecting portion is 0.1 mm to 0.5 mm.

6. The electronic device according to claim 1, wherein the fastening portion is provided with a plurality of solder joint positions, and the plurality of solder joint positions are successively arranged in a length direction of the antenna spring.

7. The electronic device according to claim 1, wherein each of the sub-fastening portions is provided with a plurality of solder joint positions, and the plurality of solder joint positions are successively arranged in the length direction of the antenna spring, or the plurality of solder joint positions are successively arranged in the thickness direction of the electronic device, or some of the solder joint positions are successively arranged in the length direction of the antenna spring, and some of the solder joint positions are successively arranged in the thickness direction of the electronic device.

8. The electronic device according to claim 1, wherein the connecting portion comprises two sub-connecting portions, and the two sub-connecting portions are respectively and fixedly connected to two opposite sides of the fastening portion in a length direction of the antenna spring; and
the abutting portion comprises two sub-abutting portions, each of the sub-abutting portions is fixedly connected to one of the sub-connecting portions, and a projection of the sub-abutting portion on the sub-connecting portion is spaced from the fastening portion.

9. The electronic device according to claim 8, wherein there are two electrically conductive elastic pieces, and each of the electrically conductive elastic pieces abuts against one of the sub-abutting portions.

10. The electronic device according to claim 1, wherein the fastening portion has a first end and a second end, the first end and the second end are disposed opposite to each other in the thickness direction of the electronic device, and a distance between the first end and the second end is equal to or greater than 0.6 mm.

11. The electronic device according to claim 1, wherein the electronic device further comprises a support plate, the support plate is located on the inner side of the frame, and is fixedly connected to the frame, the support plate is provided with a mounting groove and an avoidance groove, an opening of the mounting groove is located on a bottom surface of the support plate, and an opening of the avoidance groove is located on a groove bottom wall surface of the mounting groove; and
the antenna spring, the circuit board, and the electrically conductive elastic piece are all mounted in the mounting groove, and the fastening portion extends into the avoidance groove.

12. The electronic device according to claim 11, wherein the antenna spring comprises a first end face that faces away from a groove bottom wall of the avoidance groove, and the first end face is lower than an edge that is of the fastening surface and that faces away from a groove bottom wall surface of the avoidance groove, or the first end face is flush with the edge that is of the fastening surface and that faces away from the groove bottom wall surface of the avoidance groove.

13. The electronic device according to claim 12, wherein a distance between the first end face and the joint of the abutting portion and the connecting portion is equal to or greater than 0.2 mm.

14. The electronic device according to claim 2, wherein the frame antenna comprises a fastening surface, the fastening surface faces the inner side of the frame, the fastening portion is fixedly connected to the fastening surface, and a maximum distance between the fastening surface and a joint of the abutting portion and the connecting portion is less than 2 mm.

15. The electronic device according to claim 2, wherein the connecting portion comprises two sub-connecting portions, and the two sub-connecting portions are respectively and fixedly connected to two opposite sides of the fastening portion in a length direction of the antenna spring; and
the abutting portion comprises two sub-abutting portions, each of the sub-abutting portions is fixedly connected to one of the sub-connecting portions, and a projection of the sub-abutting portion on the sub-connecting portion is spaced from the fastening portion.

16. The electronic device according to claim 3, wherein the connecting portion comprises two sub-connecting portions, and the two sub-connecting portions are respectively and fixedly connected to two opposite sides of the fastening portion in a length direction of the antenna spring; and
the abutting portion comprises two sub-abutting portions, each of the sub-abutting portions is fixedly connected to one of the sub-connecting portions, and a projection of the sub-abutting portion on the sub-connecting portion is spaced from the fastening portion.

17. The electronic device according to claim 3, wherein the fastening portion has a first end and a second end, the first end and the second end are disposed opposite to each other in the thickness direction of the electronic device, and a distance between the first end and the second end is equal to or greater than 0.6 mm.

18. The electronic device according to claim 3, wherein the electronic device further comprises a support plate, the support plate is located on the inner side of the frame, and is fixedly connected to the frame, the support plate is provided with a mounting groove and an avoidance groove, an opening of the mounting groove is located on a bottom surface of the support plate, and an opening of the avoidance groove is located on a groove bottom wall surface of the mounting groove; and
the antenna spring, the circuit board, and the electrically conductive elastic piece are all mounted in the mounting groove, and the fastening portion extends into the avoidance groove.

19. An antenna spring, used in an electronic device, the electronic device comprises a frame antenna, and the antenna spring comprises:
a fastening portion;
an abutting portion; and
a connecting portion;
wherein the fastening portion and the abutting portion are both fixedly connected to the connecting portion, the fastening portion is fixedly connected to the frame antenna, and a projection of the abutting portion on the connecting portion is spaced from the fastening portion.

20. The antenna spring according to claim 19, wherein the fastening portion, the abutting portion, and the connecting portion are integrally molded.
